(19) United States
(12) Patent Application Publication
(10) Pub. No.: US 2022/0298954 A1
(43) Pub. Date: Sep. 22, 2022

(54) COMMON COOLING SYSTEM FOR MULTIPLE GENERATORS

(71) Applicant: Halliburton Energy Services, Inc., Houston, TX (US)

(72) Inventors: Timothy Holiman Hunter, Duncan, OK (US); Steven Howard Gray, Duncan, OK (US); David Wayne Murrell, Duncan, OK (US); Glenn Howard Weightman, Duncan, OK (US)

(21) Appl. No.: 17/206,683

(22) Filed: Mar. 19, 2021

(51) Int. Cl. F01P 3/20; F02B 63/04; F01P 7/16

(52) U.S. Cl. CPC F01P 3/20; F02B 63/044; F01P 7/165; F02B 2063/045; F01P 2060/02

(57) ABSTRACT

A common cooling system and method for multiple generators are disclosed. In certain embodiments, a system comprises a power generation unit comprising a plurality of generators, wherein the power generation unit provides power to well stimulation equipment, and a common cooling unit positioned remote from the power generation unit, wherein cooling fluid from the common cooling unit is provided to each generator of the plurality of generators in the power generation unit.

### TECHNICAL FIELD OF THE INVENTION

The present disclosure relates generally to a system and method for cooling equipment at a job site, for example, at a wellsite for oil and gas operations.

### BACKGROUND

In certain operations, including drilling, fracturing, and other oilfield operations, it may be desirable to replace gas turbines with multiple reciprocating engines to drive electric generators to reduce the environmental impact of such operations. However, the power output required of certain oilfield operations necessitates a much larger footprint of reciprocating engine electric generators, as reciprocating engines typically produce a magnitude of order less power than a gas turbine-driven generator. For example, turbines may have a more compact footprint, and may produce three to four times the power as reciprocating engines in the same space. Thus, more reciprocating engines are required, which occupy a larger footprint and take up valuable real estate at a wellsite.

Reciprocating engines produce large amounts of heat, which may be difficult to expel when multiple reciprocating engines are positioned close together. Reciprocating engines typically require cooling systems, either integrated with or attached directly to the reciprocating engine. Gas turbines, on the other hand, self-cool via the large amount of air passing through the turbines. For cooling, reciprocating engines typically comprise on-board liquid-to-air exchangers, e.g., radiators, using air intakes. Reciprocating engines must be sufficiently spaced apart from one another, such that cooling air is not recirculated between nearby or adjacent reciprocating engines. Insufficient spacing of reciprocating engines may cause insufficient cooling and poor performance of the engine-driven generators. Additionally, an on-board cooling system of a reciprocating engines is a parasitic load, decreasing the amount of available power that can be applied to electrical generation. Thus, even more real estate is needed to implement reciprocating engines to account for the same power output as gas turbines.

Reciprocating engines may be preferred due to their modular nature. Multiple reciprocating engines are typically synchronized and used together as part of a power generation unit. Reciprocating engines may be interchangeable and modular in nature, and thus the failure of a single reciprocating engine often may not require a complete halt in production. Failure of a gas turbine in a single gas turbine system on the other hand requires a shut-down of the entire operation while the turbine is repaired or serviced. A method and system of cooling multiple reciprocating engines without occupying valuable real estate near the reciprocating engines is thus desired.

### BRIEF DESCRIPTION OF THE DRAWINGS

These drawings illustrate certain aspects of one or more of the embodiments of the present disclosure, and should not be used to limit or define the claims.

FIG. 1 is a schematic block diagram of remotely cooled generators, according to one or more aspects of the present disclosure.

FIG. 2 is schematic block diagram of a remote cooling system coupled to a generator, according to one or more aspects of the present disclosure.

FIG. 3 is a schematic block diagram of a remote cooling system coupled to a generator with a heat exchanger, according to one or more aspects of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

The present disclosure relates to a common cooling system and method for electric generators, which may be used to power one or more devices or equipment at a location, such as, one or more pumps, blenders, mixers, motors, control centers, or any other types of equipment at a well services and production location. While one or more aspects of the present disclosure relate to a cooling system and method for equipment at well servicing or production locations, the present disclosure contemplates a cooling system for any type of equipment or at any type of location.

Throughout this disclosure, a reference numeral followed by an alphabetical character refers to a specific instance of an element and the reference numeral alone refers to the element generically or collectively. Thus, as an example (not shown in the drawings), widget “1a” refers to an instance of a widget class, which may be referred to collectively as widgets “1” and any one of which may be referred to generically as a widget “1”. In the figures and the description, like numerals are intended to represent like elements.

Certain embodiments according to the present disclosure may be directed to systems and methods for using a remote cooling system at a well services location to cool one or more electric generators used to power wellsite equipment. A remote cooling system may allow several reciprocating engine-driven electric generators to be placed close together, reducing the overall footprint of the power generation units. Allowing the electric generators to be placed in close proximity to one another may also simplify the cabling interconnections needed between the electric generators.

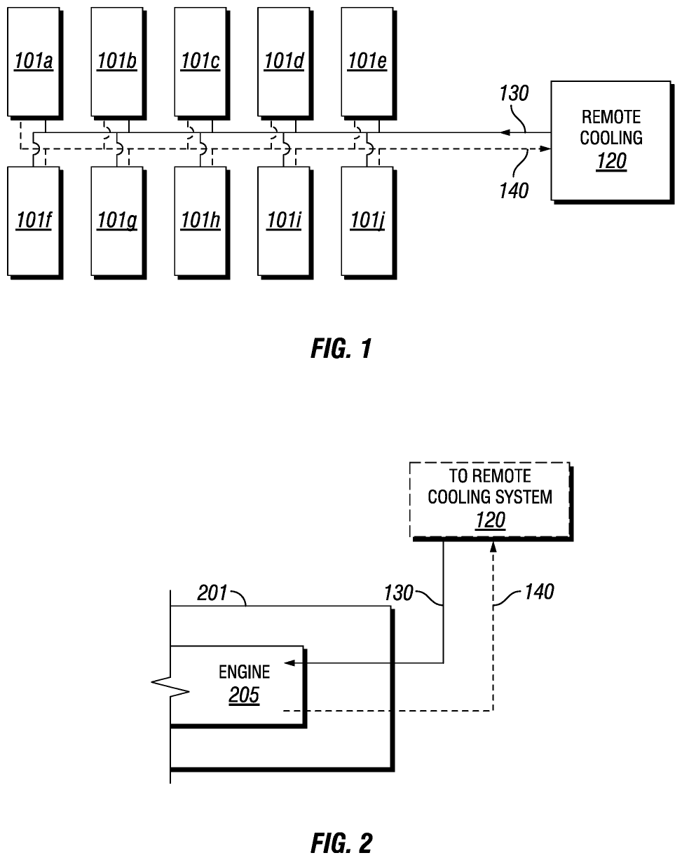

FIG. 1. depicts a block diagram of a commonly-cooled power generation system 100, in accordance with one or more aspects of the present disclosure. In certain embodiments, generators 101 may be driven by a reciprocating engine. As shown in FIG. 1, power generation system 100 may comprise a plurality of generators 101, for example, generators 101a, 101b, 101c, 101d, 101e, 101f, 101g, 101h, 101i, and 101j. However, as would be understood by one of ordinary skill in the art, power generation system 100 may comprise a fewer or greater number of generators 101 in keeping with aspects of the present disclosure. Generators 101 may be “tightly packed” or positioned close to one another such that each generator 101 is no more than, for example, two feet apart from one another. Significant space may be saved compared to on-board cooling generators which may need to be spaced 6-10 feet apart from one another (not shown). Generators 101 may be placed on a trailer or other transport vehicle such that they are easily transportable to and from a location, for example, a wellsite location. In certain embodiments, generators 101 may be sized such that they may be transported over highway infrastructure. Reciprocating engine-driven generators 101 may be used as they are lightweight and easily portable. In certain embodiments, generators 101 may be positioned on a frac spread (not shown) at a wellsite location. For example, each generator 101 may be approximately 8 feet wide by 8 feet tall by 30-40 feet long. Thus, in certain embodiments, a power generation system 100 may comprise, for example, ten generators 101 which occupy approximately 2500-3000 square feet.

In certain embodiments, a common cooling system 120 may be positioned at a distance from the one or more portable generators 101. For example, common cooling system 120 may be positioned 100-150 feet or more from the one or more portable generators 101, such that it is remote from the one or more portable generators 101. In certain embodiments, common cooling system 120 may comprise a central cooling mechanism (not shown), for example, a radiator, liquid-to-liquid heat exchanger, liquid-to-air tube-based heat exchanger, cooling tower, etc. In certain embodiments, cooling towers may be the preferred central cooling mechanism due to their ability to take advantage of latent-heat-of-evaporation directly. In certain embodiments, a liquid-to-liquid heat exchanger may use a large heat-sink liquid source such as treatment fluid. In certain embodiments, cooling may be provided by vaporization of a material such a nitrogen, natural gas, or carbon dioxide. Power generation system 100 may comprise a supply line 130 fluidically coupling common cooling system 120 to the one or more portable generators 101, for example, portable generators 101a, 101b, 101c, 101d, 101e, 101f, 101g, 101h, 101i, and 101j, as shown in FIG. 1. Supply line 130 may transport a heat-transfer fluid or cooling fluid, for example, treatment fluid water or water containing an anti-freeze agent, to the one or more portable generators 101, as shown in FIG. 1. In certain embodiments, corrosion inhibitors may be included with the heat-transfer fluid or cooling fluid to prevent damage to the generators 101, supply line 130, or any other equipment. Power generation system 100 may further comprise a return line 140 fluidically coupling the one or more portable generators 101, for example portable generators 101a, 101b, 101c, 101d, 101e, 101f, 101g, 101h, 101i, and 101j, to the common cooling system 120, as shown in FIG. 1. In certain embodiments, return line 140 may transport or deliver warmed cooling fluid from the one or more portable generators 101 back to the common cooling system 120 where the heat may be rejected and the cooling fluid re-cooled. As would be understood by one of ordinary skill in the art, supply line 130 and return line 140 may comprise any one of steel piping, flexible hoses, or any combination thereof. In certain embodiments, a manifold (not shown) may be used to facilitate the distribution of fluid between the supply line 130 and return line 140 to and from the generators 101.

FIG. 2 is an expanded block diagram depicting a common cooling system 120 coupled to a generator 201 in a direct cooling configuration. In certain embodiments, generator 201 may be any one of generators 101 as described above with respect to FIG. 1. As shown in FIG. 2, generator 201 may comprise a reciprocating engine 205. As described above, reciprocating engine 205 may produce heat during operation as it powers the generator 201. Remote cooling system 120 may provide cooling fluid via supply line 130 directly to the engine 205 of generator 201. Cooling fluid may be supplied to reciprocating engine 205 and flow through the components (not shown) of the engine 205 to remove heat from engine 205. In certain embodiments, engine 205 may further comprise a sensor (not shown) to monitor the temperature of the engine 205 to ensure that engine 205 is within proper operating temperatures and not overheated, e.g., 180-220 degrees F. After fluid the cooling fluid has been continuously circulated for a sufficient period of time, the fluid may exit the engine 205. In certain embodiments, a thermostatic valve (not shown) may be used to sense the temperature inside the engine 205 and automatically discharge the fluid once a predetermined temperature has been met. Then the cooling fluid may return to the remote cooling system 120 via return line 140, where the gained heat may be rejected from the cooling system 120 via one or more cooling mechanisms described above.

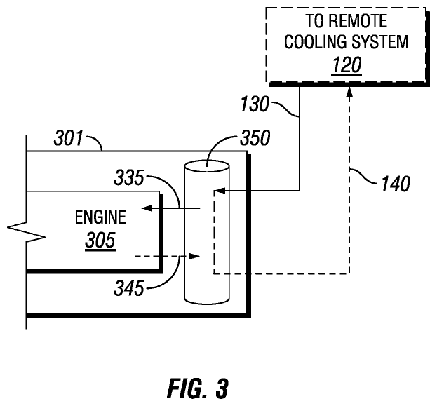

FIG. 3 is an expanded block diagram of a common cooling system 120 coupled to a generator 301 comprising a heat-exchanger 350. In certain embodiments, generator 301 may be any one of generators 101 as described above with respect to FIG. 1. Heat exchanger 350 may be positioned within, mounted to, or otherwise coupled to the generator 301 and adjacent to a reciprocating engine 305. In certain embodiments, heat exchanger 350 may comprise a liquid-to-liquid heat exchanger using a large heat-sink liquid source, for example, treatment fluid, provided by the remote cooling system 120. As described above, cooling fluid may be provided via supply line 130 from the remote cooling system 120. Generator 301 may further comprise an engine supply line 335 and an engine return line 345 for facilitating the flow of fluid between the engine 305 and heat exchanger 350. As would be understood by one of ordinary skill in the art, engine supply line 335 and engine return line 345 may comprise any material suitable for transporting fluid, e.g., stainless steel piping or flexible hosing. Cooling fluid may be fed into the heat exchanger 350 of generator 301 via a supply line 130, and likewise, fed into the engine 305 via engine supply line 335. Similar to the above with respect to FIG. 2, engine 305 may comprise a sensor or thermostatic valve (not shown) which may be used to measure the temperature in the engine 305 and discharge the fluid once a predetermined temperature has been met. Warmed engine coolant from engine 305 may be then be supplied to heat exchanger 350 via engine return line 345. A liquid-to-liquid heat exchanger 350 may transfer heat from the engine coolant fed via engine return line 345 to the common cooling fluid fed via supply line 130 without the two fluids mixing or coming into contact with one another. Then, the cooled engine coolant may exit the heat exchanger 350 via engine supply line 335 and back into the engine 305 to cool the engine 305. The warmed common cooling fluid may similarly exit the heat exchanger 350 via return line 140 and flow back to the remote cooling system 120, where the gained heat may be rejected by cooling mechanism (not shown) at remote cooling system 120. Using a heat exchanger 350 as shown in FIG. 3 rather than the direct-cooling method of FIG. 2 may help prevent corrosion to the engine components (not shown). For example, in certain embodiments, engine coolant from engine 305 may contain higher quality or higher concentration of anti-corrosion agents as compared to the cooling fluid from the common cooling system 120. Costs may be limited by using a split system and a heat exchanger 350 such that only the limited volume of engine coolant need to contain corrosion protection agents, rather than the high volume of cooling fluid from the common cooling system 120.

Referring now back to FIG. 1, power generation system 100 may be comprised of various types of generators 101, including generators 201 as described in FIG. 2 and generators 301 as described in FIG. 3, as well as generators that comprise traditional on-board cooling systems (not shown). Additionally, other generators with different types of heat transfer devices as described may be used in combination to form a power generation system 100.

Thus, the present disclosure provides an improved cooling system for generators, especially generators driven by reciprocating engines. The common cooling system and method disclosed herein provides cooling to multiple generators that are compactly positioned together to save valuable real estate at a job location. Additionally, separating the cooling system from each generator reduces the volumetric size of each generator package, which not only saves space but also reduces costs. In certain embodiments, generators may be stacked or positioned on top of one another in order to further reduce the footprint of the power generation unit. The present disclosure increases job efficiency by simplifying the cabling required between generators as a result of the ability to tightly-position the generators adjacent to or even on top of one another. Furthermore, the improved common cooling system may provide improved power generation efficiency as a higher percentage of power for each engine may be applied to electrical generation without the parasitic load of a typical on-board cooling mechanism, for example, a cooling fan.

A system and method for cooling multiple generators using a common cooling unit is disclosed. In certain embodiments, a system may comprise a power generation unit comprising a plurality of generators, wherein the power generation unit provides power to well stimulation equipment. In certain embodiments, the system may further comprise a common cooling unit positioned remote from the power generation unit, wherein cooling fluid from the common cooling unit is provided to each generator of the plurality of generators in the power generation unit.

In certain embodiments, the plurality of generators may comprise at least one reciprocating engine-driven generator. In certain embodiments, each generator of the plurality of generators may be spaced no more than two feet apart from one another. In certain embodiments, the common cooling unit may be positioned 100 feet or more from the power generation unit. In certain embodiments, the common cooling unit may comprise one or more cooling towers. In certain embodiments, the common cooling unit may comprise any one or more of a radiator, a liquid-to-liquid heat exchanger, a liquid-to-air heat exchanger, and a cooling tower. In certain embodiments, the cooling fluid may comprise an anti-corrosion agent. In certain embodiments, the cooling fluid may be transported from the common cooling unit to the power generation unit via a supply line. In certain embodiments, warmed cooling fluid may be transported from the power generation unit to the common cooling unit via a return line.

In certain embodiments, a system may comprise a generator comprising a reciprocating engine, wherein the generator provides electric power to one or more devices. In certain embodiments, the system may further comprise a common cooling unit positioned remote from the generator, wherein the common cooling unit provides cooling fluid to the generator.

In certain embodiments, the generator may further comprise a liquid-to-liquid heat exchanger, wherein cooling fluid may be circulated to the liquid-to-liquid heat exchanger. In certain embodiments, engine coolant from the reciprocating engine may be circulated to the liquid-to-liquid heat exchanger, wherein heat may be transferred from the engine coolant to the cooling fluid. In certain embodiments, the engine coolant may comprise an anti-corrosion agent. In certain embodiments, the reciprocating engine may be coupled to the liquid-to-liquid heat exchanger via an engine supply line and an engine return line.

In certain embodiments, a method may comprise positioning a plurality of reciprocating engine-driven generators adjacent to one another, positioning a cooling unit separate from and at a distance from the plurality of reciprocating engine-driven generators, and supplying a cooling fluid from the cooling unit to the plurality of reciprocating engine-driven generators.

In certain embodiments, the cooling unit may be positioned at least 100 feet from the plurality of reciprocating engine-driven generators. In certain embodiments, at least one of the plurality of reciprocating engine-driven generators may comprise a liquid-to-liquid heat exchanger. In certain embodiments, the cooling unit may comprise any one or more of a radiator, a liquid-to-liquid heat exchanger, a liquid-to-air heat exchanger, and a cooling tower. In certain embodiments, positioning the plurality of reciprocating engine-driven generators may comprise stacking at least one generator on top of another generator.

1. A system comprising:
an electric power generation unit comprising a plurality of electric power generators, each configured to generate electricity, wherein the electric power generation unit provides electricity to well stimulation equipment, and wherein each electric power generator of the plurality of electric power generators are spaced no more than two feet apart from one another; and
a common cooling unit positioned remote from the electric power generation unit, wherein cooling fluid from the common cooling unit is provided to each electric power generator of the plurality of electric power generators in the electric power generation unit, and wherein the common cooling unit is positioned 100 feet or more from the electric power generation unit.

2. The system of claim 1, wherein the plurality of electric power generators comprises at least one reciprocating engine-driven generator.

3-4. (canceled)

5. The system of claim 1, wherein the common cooling unit comprises one or more cooling towers.

6. The system of claim 1, wherein the common cooling unit comprises any one or more of a radiator, a liquid-to-liquid heat exchanger, a liquid-to-air heat exchanger, and a cooling tower.

7. The system of claim 1, wherein the cooling fluid comprises an anti-corrosion agent.

8. The system of claim 1, wherein the cooling fluid is transported from the common cooling unit to the electric power generation unit via a supply line.

9. The system of claim 1, wherein warmed cooling fluid is transported from the electric power generation unit to the common cooling unit via a return line.

10. A system comprising:
an electric power generator comprising a reciprocating engine, wherein the electric power generator provides electric power to one or more devices; and
a common cooling unit positioned remote 100 feet or more from the electric power generator, wherein the common cooling unit provides cooling fluid to the electric power generator.

11. The system of claim 10, wherein cooling fluid is circulated directly from the common cooling unit to the reciprocating engine of the electric power generator.

12. The system of claim 10, wherein the electric power generator further comprises a liquid-to-liquid heat exchanger, and wherein cooling fluid is circulated to the liquid-to-liquid heat exchanger.

13. The system of claim 12, wherein engine coolant from the reciprocating engine is circulated to the liquid-to-liquid heat exchanger, and wherein heat is transferred from the engine coolant to the cooling fluid.

14. The system of claim 13, wherein the engine coolant comprises an anti-corrosion agent.

15. The system of claim 13, wherein the reciprocating engine is coupled to the liquid-to-liquid heat exchanger via an engine supply line and an engine return line.

16. A method comprising:
positioning a plurality of reciprocating engine-driven electric generators adjacent to one another, wherein the plurality of reciprocating engine-driven electric generators are spaced no more than two feet apart from one another;
positioning a cooling unit separate from and at a distance of 100 feet or more from the plurality of reciprocating engine-driven electric generators;
generating electricity via each reciprocating engine-driven electric generator; and
supplying a cooling fluid from the cooling unit to the plurality of reciprocating engine-driven electric generators.

17. The method of claim 16, wherein the cooling unit is positioned at least 100 feet from the plurality of reciprocating engine-driven electric generators.

18. The method of claim 16, wherein at least one of the plurality of reciprocating engine-driven electric generators comprises a liquid-to-liquid heat exchanger.

19. The method of claim 16, wherein the cooling unit comprises any one or more of a radiator, a liquid-to-liquid heat exchanger, a liquid-to-air heat exchanger, and a cooling tower.

20. The method of claim 16, wherein positioning the plurality of reciprocating engine-driven electric generators comprises stacking at least one electric generator on top of another electric generator.

21. The system of claim 10, wherein the electric power generator consists of a plurality of electric power generators.

22. The system of claim 21, wherein the plurality of electric power generators are positioned adjacent to one another, and wherein the plurality of electric power generators are spaced no more than two feet apart from one another.
